(19) United States
(12) Patent Application Publication
(10) Pub. No.: US 2017/0140379 A1
(43) Pub. Date: May 18, 2017

(54) CREDIT CARD RANDOMLY GENERATED PIN

(71) Applicant: BRUCE D. DECK, Huntsville, AL (US)

(72) Inventor: BRUCE D. DECK, Huntsville, AL (US)

(21) Appl. No.: 14/944,000

(22) Filed: Nov. 17, 2015

(51) Int. Cl. G06Q 20/40; G06Q 20/34

(52) U.S. Cl. CPC G06Q 20/4012; G06Q 20/34

(57) ABSTRACT

The present invention relates to systems and methods of randomly generating a Personal Identification Number (“PIN”) for a credit or debit card. A smart phone or other mobile device generates the PIN. The PIN number is required to be generated before a credit or debit card transaction is approved by the issuing authority.

### CROSS-REFERENCE TO RELATED APPLICATIONS

This application does not claim the benefit of the priority to any provisional application, CT filing, or foreign application.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR JOINT INVENTOR

The inventor did not disclosed the invention herein prior to the 12 month period preceding the filing of his provisional application.

### BACKGROUND OF THE INVENTION

Field of the Invention

The present invention relates to systems and methods of randomly generating a Personal Identification Number (“PIN”) for a credit card or a debit card. The system and method requires the user to be in possession of both a pre-registered smart phone or other personal mobile device and the credit or debit card associated with said smart phone or personal mobile device.

Description of Related Art

Numerous inventions have been described in the prior art that randomly generate a PIN number for a credit or debit card. Nothing of these prior disclosures require the user to have in their possession a smart phone or other mobile device synched with his or her credit or debit card. The US Federal Trade Commission, Consumer Sentinel Network, US Department of Justice, estimates in a 2014 release that an annual worldwide credit card fraud totals $5.5 Billion in US Dollars. This report states that 10% of Americans have been victims of credit card fraud and 7% of Americans have been victims of debit card fraud.

Although credit card companies have been implementing new measures to prevent credit card fraud stemming from lost and stolen cards, there are not any system or method to prevent credit card fraud from internet transactions. Current security measures only address a lost or stolen card presented to a retailer and do not address transactions via internet. Currently, a user making a credit or debit card purchase via the internet enters the credit or debit card number, the name on the card, the mailing information for the cardholder, and the card verification value (“CVV”) number, which can only be accessed by looking on the front or back face of a credit or debit card. If a card is lost or stolen, someone other than the cardholder may be able to user the debit or credit card until the card is reported lost or stolen by the cardholder. There exists a need for an improved system or method of reducing credit and debit card fraud during internet purchases.

By the time a cardholder discovers that his credit or debit card has been lost or stolen, a thief may have illegally used the card to obtain merchandise or money. When a cardholder loses his or card or discovers it has been stolen, they are required to contact the issuing bank or authority to report the loss or theft. The cardholder must physically contact the issuing bank or authority via telephone, which may be burdensome and time-consuming. A system or method that gives a cardholder immediate control over his credit or debit card is needed.

Balbus (US 2015/0170137 A1) discloses a method of activating and deactivating credit cards or debit cards by initiating activation or deactivation of a credit card or debit card in an application, transmitting an activate or deactivate signal to a server of a card issuer, validating user information, and activating or deactivating the credit card or debit card. This method or system only allows a user to activate or deactivate his or her debit or credit card and does not protect a cardholder from internet theft or provide a cardholder immediate control over each and every credit or debit transaction.

Ashfield (US 2013/0008956 A1) discloses a method and apparatus for using at least a portion of a one-time password as a dynamic CVV. This method or system provides for a credit or debit card generating a dynamic CVV that is to be used as a security code for purchasing or other transactions. A card-based financial transaction is authorized in accordance with the use of a dynamic CVV by receiving a transaction authorization request for a specific credit or debit card, wherein the transaction authorization requires includes a dynamic CVV. The dynamic CVV can be compared to at least a portion of a one-time password generated for the specific credit or debit card, and the authorization can be sent to the merchant or vendor when the dynamic CVV matches all or a portion of the one-time password. This method requires the user to remember a password. Consumers are overwhelmed with the need to remember a number of passwords relating to a code to enter a home or office, a password or code to access the internet, a password to activate or deactivate a security system, a code to gain entrance to their vehicle, etc. Many of these passwords must be changed every ninety days, or at some preset interval, which forces consumers to continuously remember new passwords. Most consumers use the same password for all accounts, which reduces security because a thief with a cardholder's password may be able to access a number of his or her accounts, including unfettered access to their credit and/or debit cards.

Today, almost all consumers have a smart phone or personal mobile device. A method or system of providing security for credit and/or debit card purchases that incorporates the cardholder's personal smart phone will allow the cardholder to have ultimate control over his credit and/or debit card.

### BRIEF DESCRIPTION OF THE SEVERAL VIEWS OF THE DRAWINGS

FIG. 1 depicts a flow chart depicting the installation of the Credit Card Randomly Generated PIN application upon a mobile device.

FIG. 2 is a flow chart depicting the installation of the Credit Card Randomly Generated PIN application upon a mobile device using the invention herein.

FIG. 3 illustrates the flow of information from the mobile device to a credit card or bank server.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, et., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an, embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified embodiment. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

The present invention is directed to a system and method of randomly generating a temporary PIN wherein said PIN is required to complete a credit card or debit card transaction face-to-face with a merchant or via the internet. The method and system allows a user to prevent the fraudulent use of their credit or debit card because the card cannot be used unless the user has simultaneous possession of both the smart phone registered with the credit or debit card and the debit card.

The term “application” as used herein refers to a computer software application (“APP”) that is stored on a computer readable media and may be run and operated on a mobile device. Preferably, this APP may be run and operated on a mobile device with a touch screen. Alternatively, this APP may be run and operated on a desktop or laptop computer that supports APPs. The term “mobile device” as used herein refers to any type of portable computing device, including, but not limited to, smart phones, Apple phones, Android™ phones, mp3 players, tablet computers, and Microsoft™ device.

“Credit card” as used herein includes any type of card issued by a bank, a business, or a merchant that allows a cardholder to purchase goods or services, or to obtain a cash advance on credit. “Debit card” as used herein includes any type of card issued by a bank, business, or merchant that allows the cardholder to transfer money electronically from one account to another account. “Credit card” and “debit card” may include any gift card or prepaid card. And, the terms “credit card” and “debit card” may be used interchangeably.

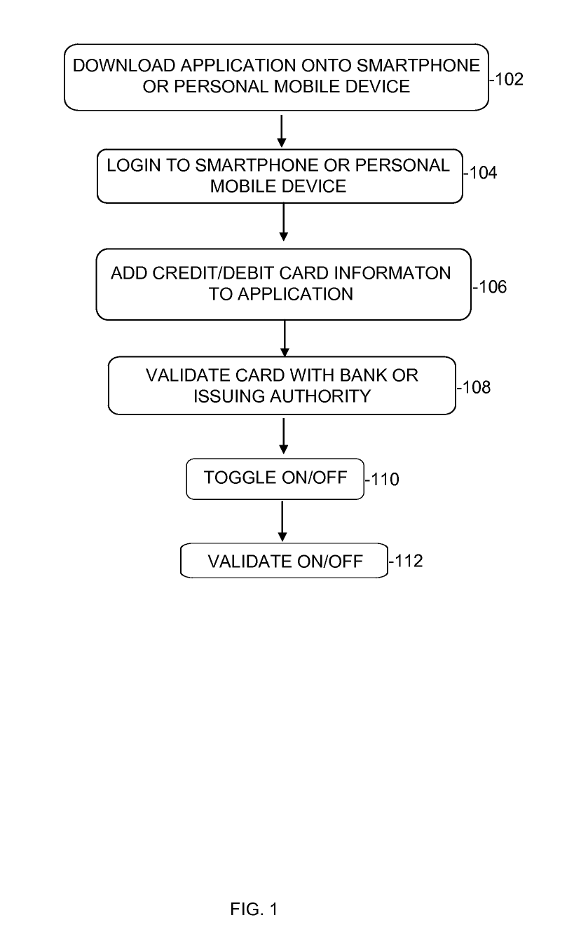

FIG. 1 is a flow chart depicting chart depicting the installation of the Credit Card Randomly Generated PIN application upon a mobile device. At step 102, the cardholder downloads the APP onto his or her smart phone or mobile device from a database of applications. A username, password, and security question can be set up upon downloading and launching the application. After successfully downloading the APP, the cardholder must “Login” to the smart phone or mobile device, step 104. Step 104 may require the cardholder to set up a password with the APP for future “Login” purposes. The cardholder adds his or her credit or debit card information to the application at step 106. The cardholder may add his or her credit or debit card number, the expiration date of said card, the cardholder name and billing address, the CVV, the card security code (“CSC”), the card verification number (“CVN”), the card verification code (CVVC), the verification code (V-code, the card verification code (“CVV2”), type of card, issuing company, issuing bank, routing number, account number, password for the account, a combination of any of the foregoing, or any relevant information. Additionally, the cardholder must add information relating to his smart phone or mobile device that is to receive the temporary PIN, including, but not limited to, the telephone number associated with the phone or device, the telephone company owning said telephone number, the account number associated with the telephone service for the smart phone or mobile device, and any other information. Any or all information or signals sent or received by the APP can be encrypted by an encryption mechanism and by any suitable encrypting software with appropriate security.

At step 108, the APP will validate that the credit or debit card information provided by the cardholder. This may be done by having the APP complete a charge or debit. For example, the APP may charge the cardholder's credit account the sum of $1.00 to validate that the cardholder information provided is correct. Next, at step 110, the APP will toggle “OFF” when the cardholder is not desiring to enter a credit card or debit card transaction. When the cardholder desires to make a credit card or debit card purchase, the cardholder will toggle “ON” at step 110 to begin using the APP. At step 112, the cardholder may “Login” to the APP using a password previously selected at step 104, above.

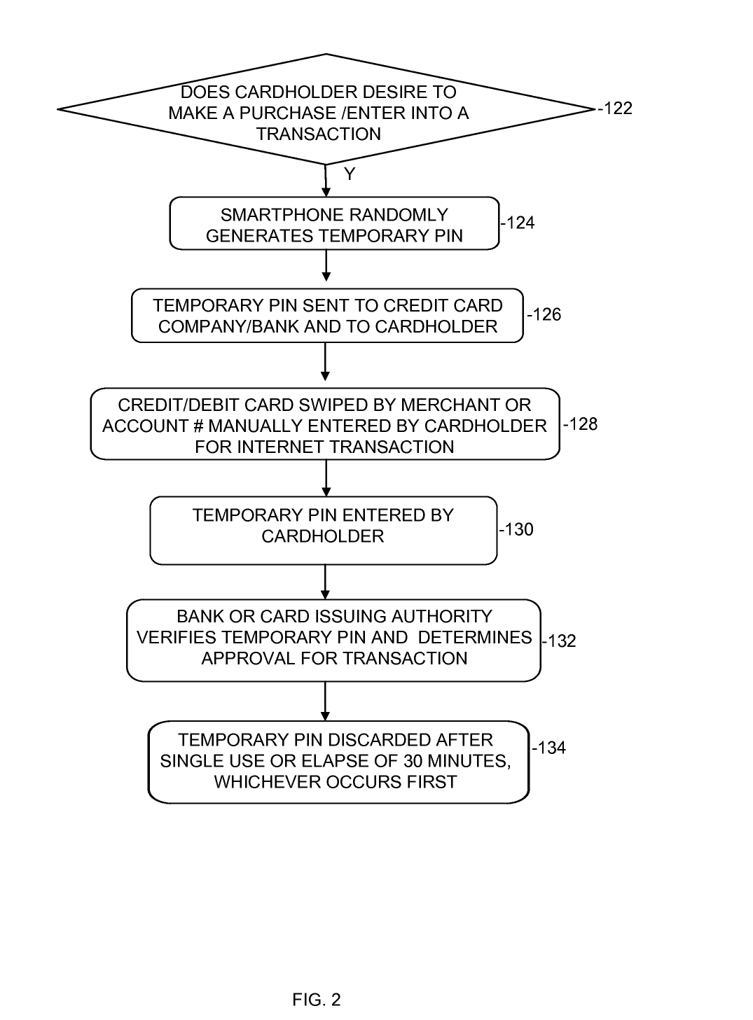

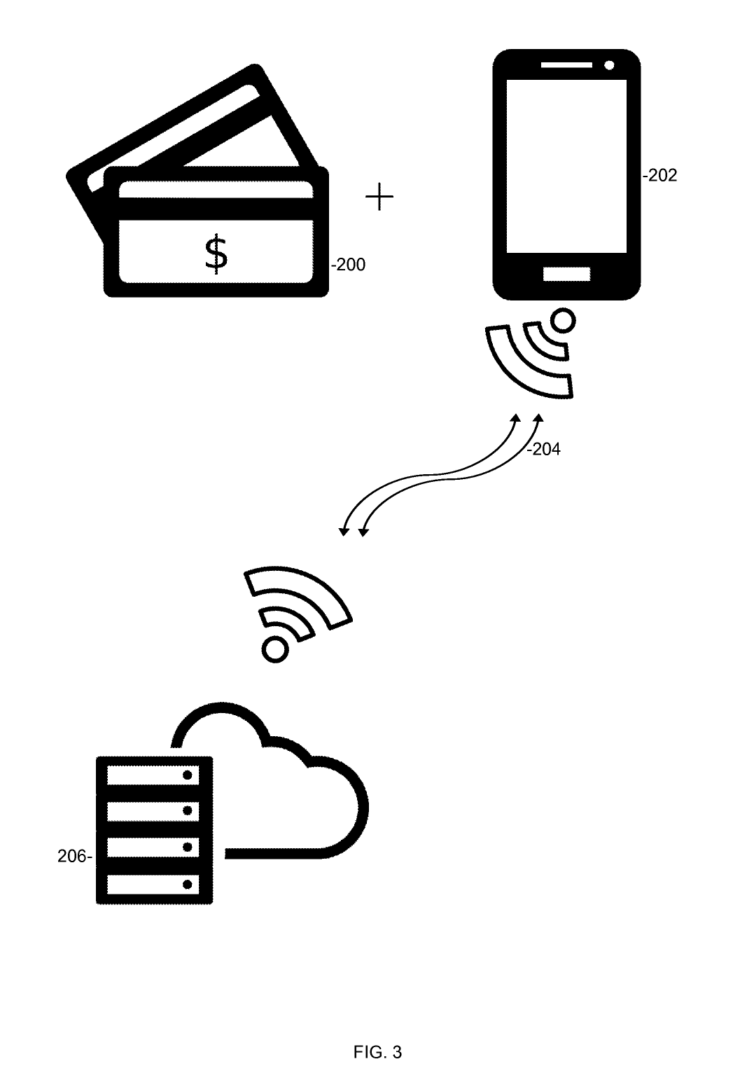

FIG. 2 is a flow chart depicting the installation of the Credit Card Randomly Generated PIN application upon a mobile device using the invention herein. If a cardholder desires to make a credit or debit card purchase or enter into a financial transaction, at step 122, the cardholder taps the smart phone or mobile device to initiate a transaction. A cardholder may log into the APP at step 110 (shown in FIG. 1). The cardholder selects the card he or she desires to use for the transaction from among those listed with the APP and displayed by the smart phone or mobile device, and enters the correct password to validate the chosen card at step 112 (shown in FIG. 1). One tap of a button on the screen of a smart phone or mobile device at step 124 initiates the smart phone 202 to randomly generate a temporary PIN. The smart phone 202 transmits the temporary PIN via encrypted signal 204 (shown in FIG. 3) wirelessly to server 206 (shown in FIG. 3) of the issuing bank, merchant, or company at step 126. The PIN generated will be a single use PIN that will be discarded if not used within 30 minutes, or other predetermined time period.

The merchant swipes the credit or debit card at step 128. The card may be a smart card with a chip that is inserted into a card processing terminal. During internet transactions, the cardholder will manually entered required into prompted fields on a computer screen. At step 130, the cardholder enters the temporary PIN that was generated at step 124 by smart phone 202. The temporary PIN entered at step 130 is transmitted via encrypted signal 204 wirelessly to server 206 of the issuing bank, merchant, or company. The issuing bank, merchant, or company verifies that the temporary PIN entered by the cardholder at step 130 is correct at step 132. The issuing bank, merchant, or company discards the temporary PIN after either a single use or after the lapse of a specified period of time, whichever occurs first. This method ensures that a lost or stolen credit card will not be usable because the smart phone 202 synched to the account must be present to randomly generate a PIN number before each and every transaction. This provides a cardholder with the ultimate security by allowing the cardholder to limit the use of his or her credit or debit card to particular transactions authorized immediately prior to the particular transaction.

FIG. 3 illustrates the flow of information from smart phone 202 or other mobile device to credit card or bank server 206 via wireless transmission. FIG. 3 depicts the requirement that a cardholder be in possession of both the credit or debit card 200 and smart phone 202 or other mobile device to initiate a credit or debit card transaction.

I hereby claim:

1. A method of randomly generating a dynamic personal identification number comprising:
a mobile device randomly generates said dynamic personal identification number upon being prompted by a user;
said personal identification number is used to authenticate a single credit card or debit card transaction;
said personal identification number expires if not used within a predetermined time period; and
said credit card or debit card can not be used for any transaction lacking said dynamic personal identification number.

2. The method of claim 1 further comprising a user manually entering said personal identification number in order to transact an internet credit card or debit transaction.

3. The method of claim 1 further comprising a user manually entering said personal identification number into a keypad in order to enter into a credit card or debit card transaction.

4. The method of claim 1 wherein said mobile device transmits said personal identification number to the authority issuing said credit card or debit card.

5. The method of claim 1 wherein said mobile device is a smart phone.

6. The method of claim 1 wherein said mobile device is an electronic notebook.

7. A system wherein an application is installed on a mobile device for randomly generating a dynamic personal identification number comprising:
said application is downloaded onto a mobile device;
said mobile device randomly generates said dynamic personal identification number upon being prompted by a user;
said dynamic personal identification number is used to authenticate a single credit card or debit card transaction;
said dynamic personal identification number expires if not used within a predetermined time period; and
said credit card or debit card can not be used for any transaction lacking said dynamic personal identification number.

8. The system of claim 7 further comprising a user manually entering said dynamic personal identification number in order to transact an internet credit card or debit transaction.

9. The system of claim 7 further comprising a user manually entering said dynamic personal identification number into a keypad in order to enter into a credit card or debit card transaction.

10. The system of claim 7 wherein said mobile device transmits said dynamic personal identification number to the authority issuing said credit card or debit card.

11. The system of claim 7 wherein said mobile device is a smart phone.

12. The system of claim 7 wherein said mobile device is an electronic notebook.
